(19) United States
(12) Patent Application Publication
(10) Pub. No.: US 2017/0123618 A1
(43) Pub. Date: May 4, 2017

(54) DYNAMIC USER INTERFACE FOR MAP APPLICATIONS

(71) Applicant: Mark Dalton Porcella, Portland, OR (US)

(72) Inventor: Mark Dalton Porcella, Portland, OR (US)

(21) Appl. No.: 15/343,789

(22) Filed: Nov. 4, 2016

Related U.S. Application Data
(60) Provisional application No. 62/250,907, filed on Nov. 4, 2015.
(60) Provisional application No. 62/375,556, filed on Aug. 16, 2016.

(51) Int. Cl. G06F 3/0485; G06F 3/0481

(52) U.S. Cl. CPC G06F 3/0485; G06F 3/04817

(57) ABSTRACT

A user interface for a digital map application having map scrolling capabilities may include a screen-static reference point, which may be indicated by a corresponding interaction icon. The map may be scrollable relative to the screen, while the reference point remains stationary. Accordingly, a point of interest on the map may be scrolled into proximity with the reference point, which may trigger a display of information relating to the point of interest. In some examples, the map may be automatically scrolled to place a nearby point of interest into registration with the reference point. In some examples, information relating to a distance and/or projected route between the reference point and a point of interest may be dynamically displayed as the map is scrolled.

### CROSS-REFERENCES

This application claims the benefit under 35 U.S.C. §119(e) of the priority of U.S. Provisional Patent Application Ser. No. 62/250,907, filed Nov. 4, 2015, and U.S. Provisional Patent Application Ser. No. 62/375,556, filed Aug. 16, 2016, the entireties of which are hereby incorporated herein by reference for all purposes.

### FIELD

This disclosure relates to systems and methods for user interaction with mobile mapping applications. More specifically, the disclosed embodiments relate to systems and methods for selecting, interacting with, and communicating information relating to points of interest on a software map application having map scrolling capabilities.

### INTRODUCTION

Map related applications on mobile platforms have become more and more ubiquitous over the past several years. Unlike the paper maps of days gone by, and even unlike previous digital maps on desktop personal computers, users of today's mapping applications (apps) interact with the programs through touch and voice. These apps are now used on mobile devices, including smart phones, car dashboard systems, tablet devices, and wearable computers. As such, device manufacturers and app developers have begun to build in capabilities for updating the maps based on a user's current location, the user's preferences, and on known information about the surrounding area, as well as standard geographic information system (GIS) data. This presents a technical problem—how to present the information and how to provide a meaningful yet uncluttered method of user interaction. Various user interfaces and methods have been attempted. Known methods can be cumbersome and/or difficult to navigate, especially with respect to selection of one or more points of interest on a displayed map.

### SUMMARY

The user interfaces presented herein, suitable for use with software map applications having map scrolling capabilities, provide useful and efficient features for selecting, manipulating, and previewing points of interest and routes on a map.

In some embodiments, a method, implemented in a data processing system, may include: displaying, on a screen of an electronic device, a scrollable map, one or more map static points on the map, and an interaction icon, wherein the interaction icon indicates an interaction location that is fixed relative to the screen; determining, on a substantially continual basis as the map is scrolled relative to the interaction location, a first distance between the interaction location and a first map static point of the one or more map static points; comparing the first distance to a selected threshold distance; and automatically displaying on the screen, in response to the first distance being less than the threshold distance, information relating to the first map static point.

In some embodiments, a computer-implemented digital map application may include: a digital map application configured to display, on a screen of an electronic device, a scrollable map, one or more map static points on the map, and an interaction icon, wherein the interaction icon corresponds to an interaction location that is fixed relative to the display; and a user interface of the map application configured to automatically display indicia relating to a continually-updated distance between the interaction location and a selected one of the one or more map static points, as the map is scrolled relative to the interaction location.

In some embodiments, a computer program product for interacting with a scrollable digital map may include: a non-transitory computer-readable storage medium having computer-readable program code embodied therewith, the computer-readable program code configured to cause a data processing system to provide a graphical user interface, the computer readable program code comprising: at least one instruction to display, on a screen of an electronic device, a scrollable map, one or more map static points on the map, and an interaction icon, wherein the interaction icon indicates an interaction location that is fixed relative to the screen; at least one instruction to determine, on a substantially continual basis as the map is scrolled relative to the interaction location, a first distance between the interaction location and a first map static point of the one or more map static points; at least one instruction to compare the first distance to a selected threshold distance; and at least one instruction to, in response to the first distance being less than the threshold distance, automatically display, on the screen, information relating to the first map static point.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram showing various features of an illustrative user interface for a mapping application.

FIG. 2 is a first screen image of an illustrative mapping application having a user interface (UI) in accordance with aspects of the present disclosure.

FIG. 3 is a second screen image of the UI of FIG. 2, after scrolling the map to place a static reference point closer to a point of interest.

FIG. 4 is a third screen image of the UI of FIG. 2, showing information displayed in response to the static reference point being within a selected distance of the point of interest.

FIG. 5 is a fourth screen image of the UI of FIG. 2, showing the point of interest after automatic scrolling to the static reference point.

FIG. 6 is a fifth screen image of the UI of FIG. 2, showing changes in the display after the user selects the point of interest.

FIG. 7 shows steps of an illustrative method for providing a user interface for a mapping application.

FIG. 8 is a screen image of an illustrative mapping application having a dynamic distance indication system in accordance with aspects of the present disclosure.

FIG. 9 is a first screen image of an illustrative mapping application having an illustrative dynamic distance indication system, illustrating functionality relating to distance indication as the user scrolls away from an exemplary map static point.

FIG. 10 is a second screen image showing the system of FIG. 9, and illustrating a route preview function

FIG. 11 is a third screen image showing the system of FIG. 9, and illustrating a waypoint and route selection function.

FIG. 12 is a fourth screen image showing the system of FIG. 9, and illustrating distance indication as the user scrolls away from the waypoint of FIG. 11.

FIG. 13 is a fifth screen image showing the system of FIG. 9, and illustrating the route preview function with multiple-point routing.

FIG. 14 is a sixth screen image showing the system of FIG. 9, and illustrating the waypoint and route selection function for a second waypoint.

FIG. 15 is a schematic diagram of various components of an illustrative data processing system.

FIG. 16 is a schematic representation of an illustrative computer network system.

### DESCRIPTION

Various aspects and examples of a dynamic user interface (UI) (which may include a distance indication and/or route preview system) for computer-generated interactive map applications, as well as related methods, are described below and illustrated in the associated drawings. Unless otherwise specified, a dynamic map UI in accordance with aspects of the present disclosure, and/or its various components may, but are not required to, contain at least one of the structure, components, functionality, and/or variations described, illustrated, and/or incorporated herein. Furthermore, the process steps, structures, components, functionalities, and/or variations described, illustrated, and/or incorporated herein in connection with the present teachings may, but are not required to, be included in other similar UIs, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### DEFINITIONS

The following definitions apply herein, unless otherwise indicated.

“Substantially” means to be essentially conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

Overview

In general, a map user interface (UI), also called a map graphical user interface (GUI), in accordance with aspects of the present disclosure may include a static reference location on a user's screen, which may be represented by an icon or other graphical element or pictogram. In some examples, the graphical element may include a target-like icon, centered on or otherwise indicating the static reference location. The static reference location remains fixed relative to the screen, and may accordingly be referred to as a reference point. In some examples, the static reference location is fixed at the geometrical center of the screen (or some meaningful portion of the screen). The map may be scrolled, panned, rotated, zoomed, or otherwise manipulated “under” the reference point and its associated graphical element.

As the user moves or zooms the map, features shown on the map will move toward and away from the fixed reference point, in contrast to systems wherein the reference point (e.g., a mouse pointer) is moved toward and away from map features. Map manipulation may be performed by any suitable method, such as using a touch interface, voice command, mouse, joystick, scroll wheel/ball, stylus, device orientation, and/or the like, or any combination of these. Selection of a point of interest (POI) on the map may be performed by bringing that POI close to the fixed reference point. This is in contrast with known systems, in which a POI is selected by tapping or clicking on the POI directly. The tapping method requires the user to obscure the visibility of the POI during the selection process and is frequently inaccurate or overly sensitive relative to the tool being used (e.g., a finger). This is especially true when several potential POIs are closely grouped. Selection of a POI in accordance with the present teachings improves the UI, inter alia, by allowing a user to scroll the map (a coarse and interaction location-agnostic process) until the POI is selected, rather than requiring accurate selection by tapping (an inherently inaccurate process).

In some examples, distance-related information may be displayed by the system as the user scrolls the map. For example, the system may automatically determine and display a geographical distance between a selected POI and the map location corresponding to the fixed reference point. This distance information may be updated continually, and displayed in real time as the user scrolls. In some examples, pausing of scrolling may result in the display of a route preview, showing a turn-by-turn path of the segment between the POI and the present location at the reference point. Examples of this UI are described in further detail below.

Aspects of the map UI, including aspects of the dynamic distance and route preview indicator, may be embodied as a computer method, computer system, or computer program product. Accordingly, aspects of the map UI may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the map UI may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the map UI may be written in one or any combination of programming languages, including an object-oriented programming language such as Java, Smalltalk, C++, and/or the like, and conventional procedural programming languages, such as C. Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the map UI are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks.

Any flowchart and/or block diagram in the drawings is intended to illustrate the architecture, functionality, and/or operation of possible implementations of systems, methods, and computer program products according to aspects of the map UI. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### EXAMPLES, COMPONENTS, AND ALTERNATIVES

The following sections describe selected aspects of exemplary map UIs as well as related systems and/or methods. The examples in these sections are intended for illustration and should not be interpreted as limiting the entire scope of the present disclosure. Each section may include one or more distinct examples, and/or contextual or related information, function, and/or structure.

Illustrative User Interface for Map Applications

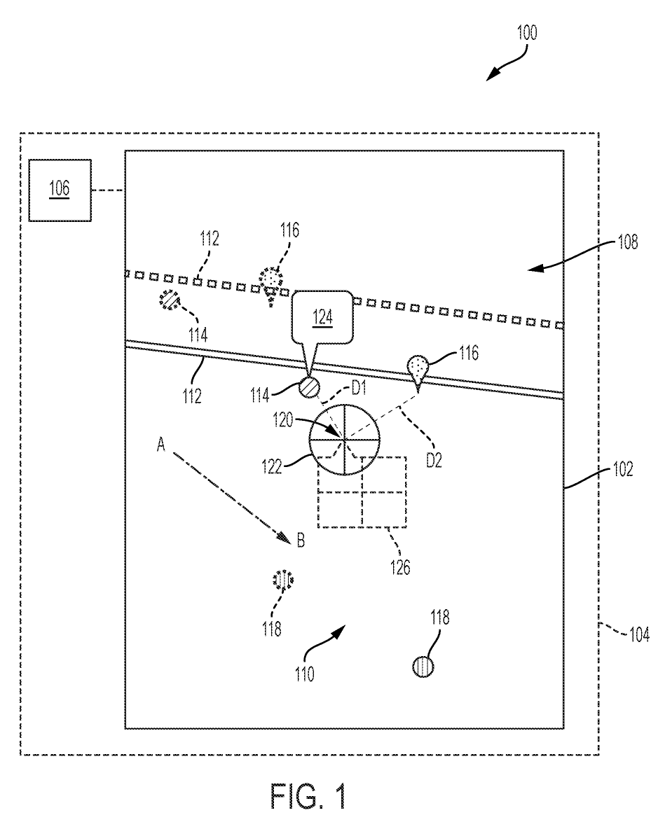

As shown in FIG. 1, this section describes a map user interface (UI) system having improved selection features relating to points of interest, generally indicated at 100. Note that FIG. 1 shows a map and UI both before and after a user scrolls the map, by swiping or dragging the map from point A to point B. Map elements with the map at point A are shown in dotted lines. Map elements with the map at point B are shown in solid form.

System 100 includes a variety of graphical elements shown on a display 102, also referred to as a screen or human-machine interface (HMI). Display 102 is associated with (e.g., part of) an electronic device 104, which is an example of a data processing system (described further below). Electronic device 104 may include a mobile device, such as a smart phone, a tablet, or a wearable (e.g., a smart watch). A mapping program or application 106 may be executed by a processor of the electronic device. Application 106 may function to provide and update the display images, perform associated tasks, etc.

A map 108 is displayed on screen 102, and is overlaid with graphical elements 110, each of which conveys information to a user. For example, graphical elements 110 may include visual icons representing a street 112, a first point of interest (POI) 114, a second POI 116, and a third POI 118.

Each POI, 114, 116, 118, may include any suitable geographic location of interest to the user, such as an address, a geographic feature (e.g., a mountain or butte), a landmark, a way point, etc. A POI may be added by mapping application 106, such as by inclusion of known landmarks, or by a user, such as through a POI addition process supported by the mapping application. Different POIs may have different icons or visual features (e.g., colors or shapes).

Screen 102 may include a fixed interaction location 120, interchangeably referred to as a reference point or a target. Reference point 120 is fixed relative to the screen or device, such that scrolling or zooming of the underlying graphics (e.g., map) does not change the size or position of the reference point. Reference point 120 may be represented graphically on the screen by any suitable icon 122 or pictogram, such as a bullseye, targeting sights, a polygon, a reticle (e.g., cross hairs), a dot or spot, an arrow, an open circle, and/or the like, or by a combination of these, or by no icon at all. Icon 122 corresponding to reference point 120 may be partially transparent or see-through, or may be absent. In some examples, icon 122 may be user-selectable from a plurality of suitable icons. Reference point 120 may be disposed at any suitable location on the screen. In some examples, reference point 120 is disposed at the geometric center of the screen or of a display portion of the screen (e.g., a window). In some examples, reference point 120 may be modified (e.g., selectively repositioned) by the user.

In operation, using the example shown in FIG. 1, when a user repositions map 108 by swiping or dragging from point A to point B, POI 114 and POI 116 move closer to the screen-static (i.e., screen-stationary) reference point 120. Similarly, POI 118 moves farther away from location 120. As described further below, program 106 may automatically determine which POI is closest to location 120. This may be done, in part, by comparing distance D1 (from location 120 to POI 114) to distance D2 (from location 120 to POI 116). Because D1 is less than D2, it will be determined in this example that POI 114 is the closest POI. If D1 is less than a selected threshold distance, program 106 may cause the appearance of POI 114 to change. For example, identifying and/or other information may be displayed, such as in a pop-up bubble 124. In other examples, the closest POI may additionally or alternatively change the appearance of the icon, such as by changing color, size, transparency, and/or the like. In some examples, the icon may change completely or partially, such as into a different icon.

When the user pauses or stops scrolling, such as by removing a finger from the screen, program 106 may auto-scroll map 108 to place the closest POI (e.g., POI 114) at a selected screen location relative to interaction location 120. For example, map 108 may be automatically repositioned such that POI 114 is just above or exactly on reference point 120. In some examples, such auto-scrolling may only occur if the closest POI is also within a selected threshold distance to the reference point.

Additionally or alternatively, upon cessation of scrolling, an interaction area 126 (also referred to as a user interaction space) may be presented to the user. Area 126 may include any suitable interaction elements or combination of elements, such as one or more buttons, text, menu(s), etc. Area 126 may be customizable by the user, may be situational (e.g., presenting different elements depending on the POI), and/or may include a standard set of commands, e.g., relating to the overall purpose of the program or map type.

### Illustrative Embodiment of a Map UI

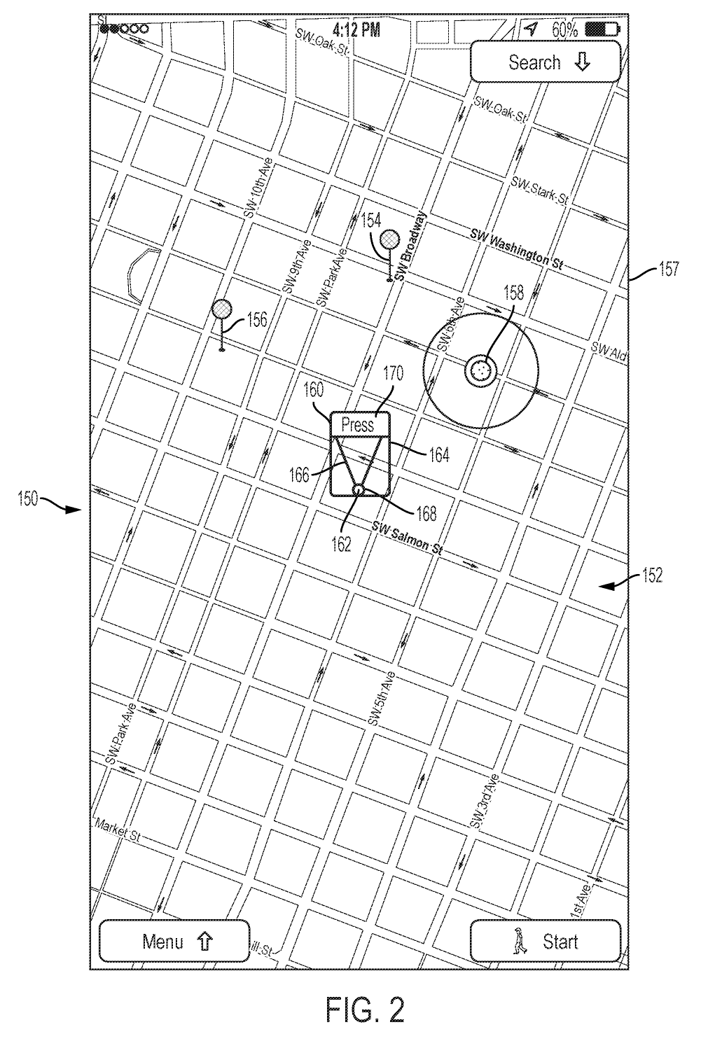

As shown in FIGS. 2-6, this section describes a user interface (UI) system for software map applications having map scrolling capabilities, the UI system generally indicated at 150. UI system 150 is an example of UI system 100, described above. Accordingly, similar components may be labeled with similar reference numbers.

FIG. 2 is a screen shot of system 150, showing an interactive map 152 and two illustrative points of interest, indicated at POI icon 154 and POI icon 156, on a display 157 of a device (e.g., a smart phone or tablet). In this example, POI icons 154 and 156 have been programmatically added to display 157, e.g., in response to a search by the user. For example, POI icons 154 and 156 may represent the locations of coffee shops nearby the user's current position, which is indicated by a user-position icon 158. Icons 154, 156, and 158 may include any suitable graphical indicator that is stationary with respect to map 152. For example, icons 154 and 156 are represented as push-pins, and icon 158 is a pulsating dot. Other icons may be used without departing from the scope of the present disclosure. As indicated above, the software may add or remove icons, for example, as the result of a search algorithm, e.g., displaying all locations meeting the search criteria. For ease of discussion, these and other icons may be referred to as their respective geographical correlates. For example, POI icon 154 may be interchangeably referred to as POI 154.

An interaction icon 160 is displayed in a fixed location with respect to display 157, such that icon 160 indicates the location of a reference point 162. Reference point 162, in this example, is located at a geometrical center of display 157. As described above with respect to reference point 120, reference point 162 is a fixed location on the display, such that map 152 and other display components (e.g., POI 154 and 156) are scrollable and zoomable under and around the stationary reference point and its corresponding icon 160. In this example, icon 160 comprises a rounded rectangle 164 having an internal “V” 166 with an open circle 168 at its vertex. Circle 168 indicates the location of reference point 162. An upper region of rectangle 164 includes indicia 170, such as a textual instruction (e.g., “Press”) indicating how the user may interact with icon 160.

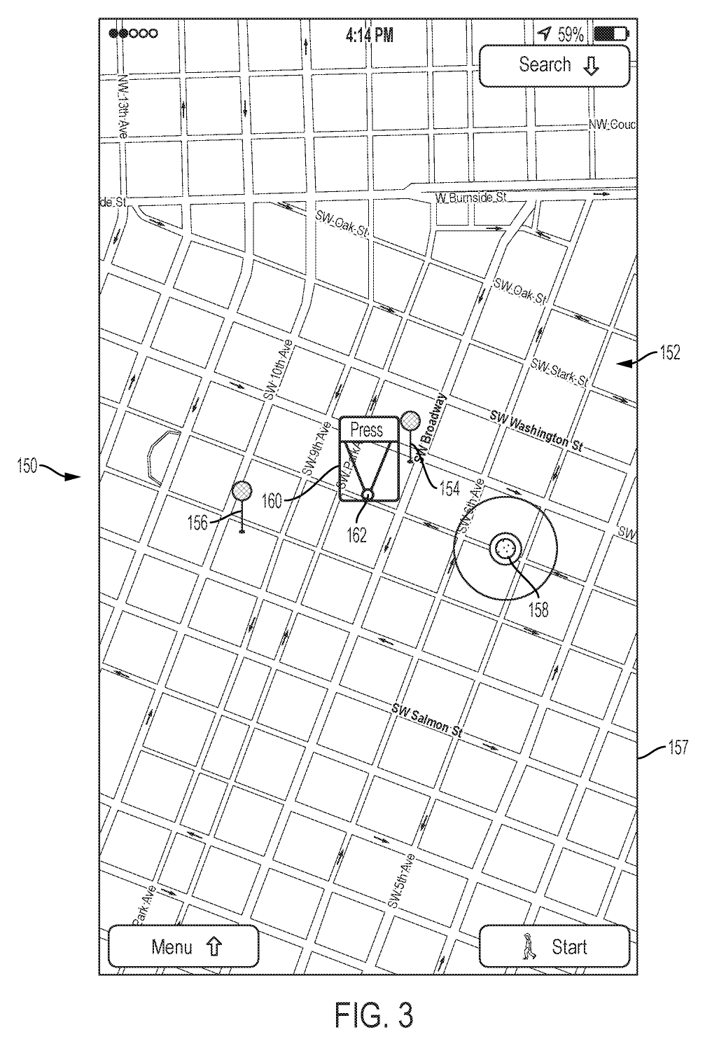

FIG. 3 is another screen shot of display 157, after scrolling the map generally downward, such that icon 160 is now in closer proximity to POI 154 and 156. As depicted in FIG. 3 and elsewhere, the position of map 152 has changed, relative to display 157, while icon 160 and reference point 162 have remained in the center of the display. In this example, POI 154 is the closest point of interest to the reference point. However, no actions have been triggered.

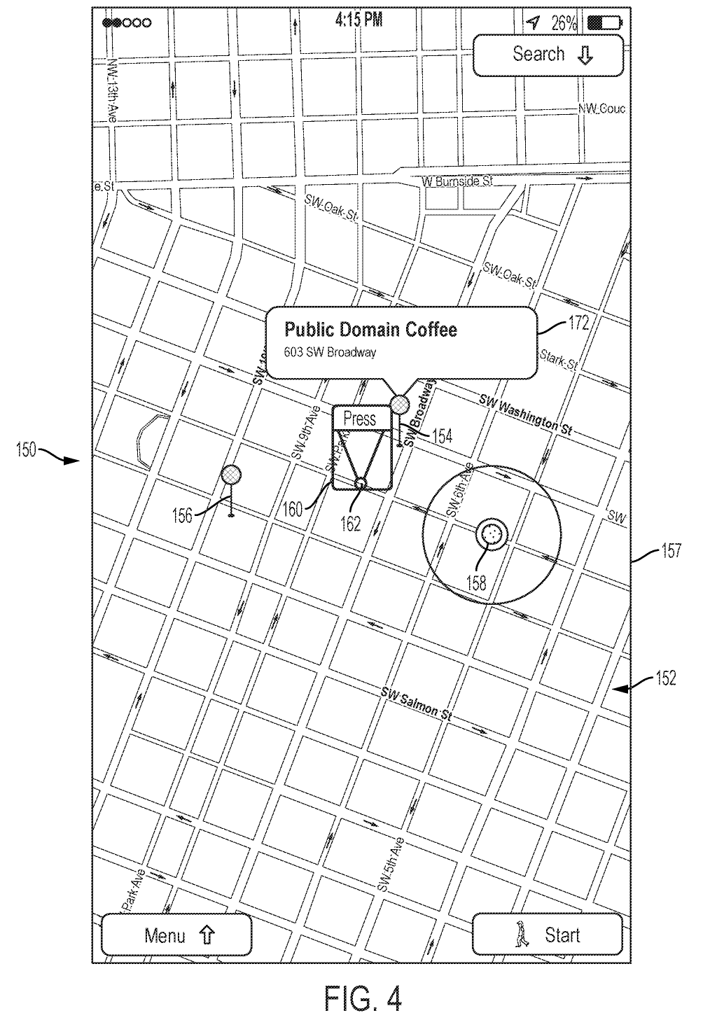

Turning to FIG. 4, scrolling of map 152 has continued, such that POI 154 is now within a selected threshold distance of reference point 162. In other words, the POI has become “close enough” to the central interaction location to trigger the display of additional information. This automatically triggers the controlling program to display POI-specific information about POI 154 adjacent to its icon. Specifically, the name of the establishment at that geographical location/address is displayed in a pop-up bubble 172 adjacent and/or extending from the POI. If the user continues to scroll the map, bubble 172 may remain visible until the POI is beyond the threshold distance from the reference point.

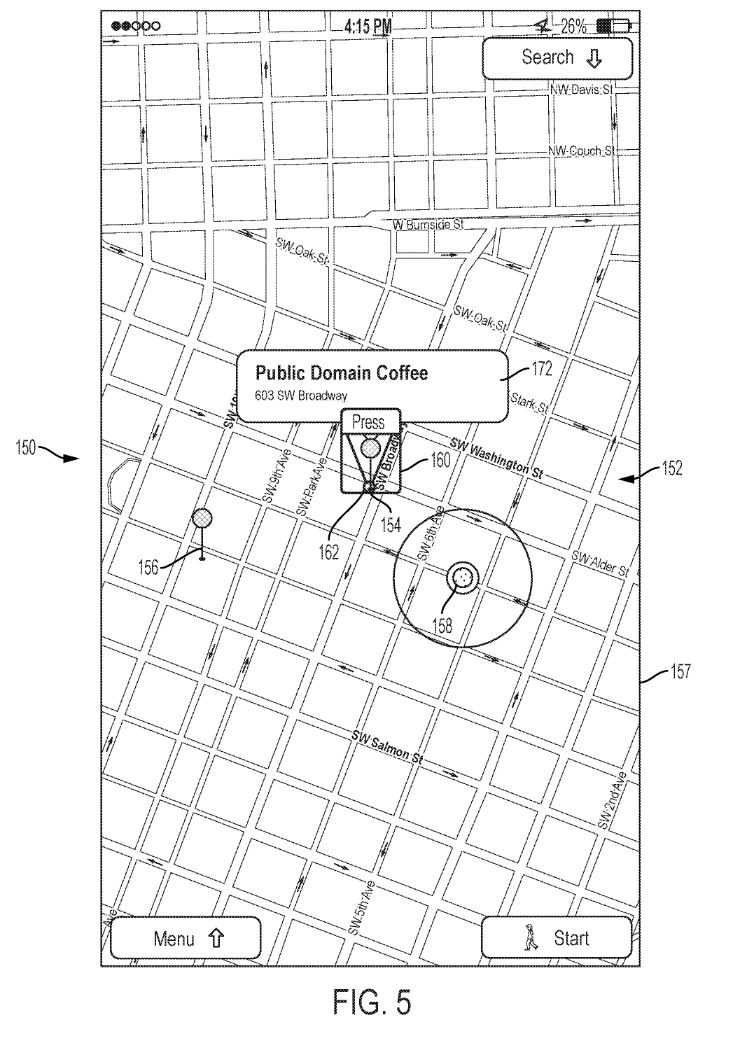

However, if the user stops or pauses scrolling, e.g., as evidenced by removal of a finger or stylus from the screen, the map will automatically be scrolled to the central reference point. In some examples, this automatic scrolling may be instantaneous upon cessation of scrolling. FIG. 5 depicts what would happen to system 150 in response to the user releasing the screen when POI 154 is in the position shown in FIG. 4. Because POI 154 was within the threshold distance set by the program, the map has been automatically scrolled to place POI 154 directly onto (i.e., under) the interaction location (reference point 162).

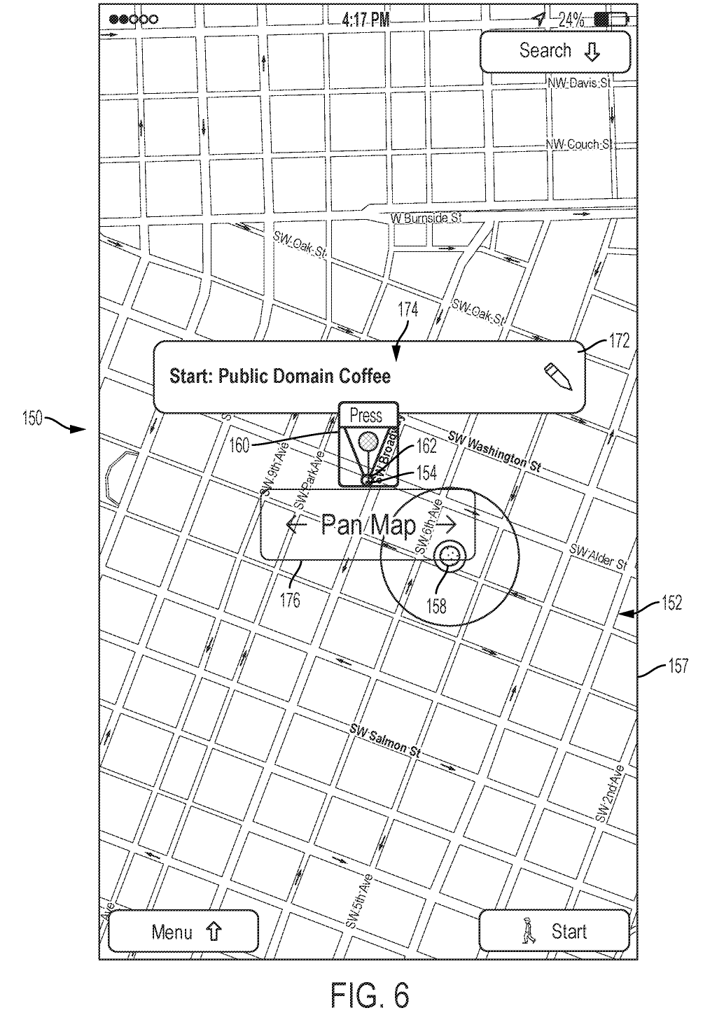

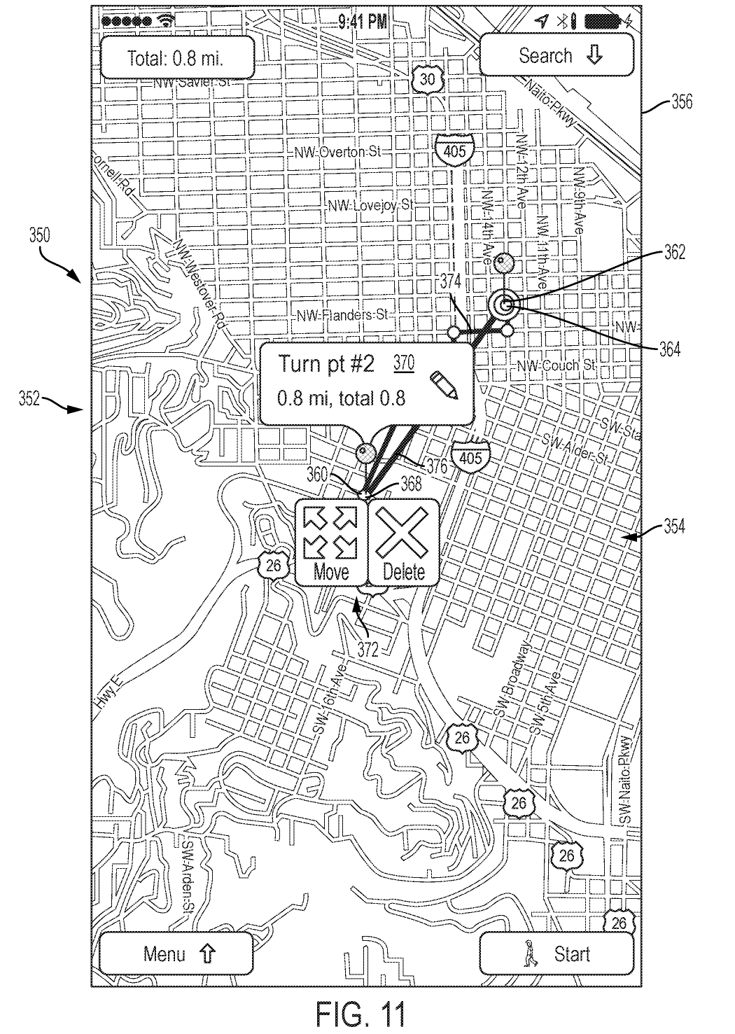

FIG. 6 shows system 150 after the user has selected POI 154 by, e.g., tapping or pressing on interaction icon 160. Similar results would occur if the user selected POI 152 or any other location. In some examples, the POI icon may be created (if not already present) and/or may be altered, such as by changing color to indicate a user-selected map point. Here, pop-up bubble 172 has been converted to an editable label 174, and a user menu and instruction space 176 has been displayed adjacent to interaction icon 160. Menu and instruction space 176 here includes instructions to pan the map to select or establish a path and/or second map point. In some examples, space 176 may additionally or alternatively include command buttons or selectable features, such as a “move” button and/or a “delete” button to operate on the selected POI (see, e.g., FIG. 11). In some examples, the contents of space 176 may change situationally and/or after an elapsed time.

Illustrative Method

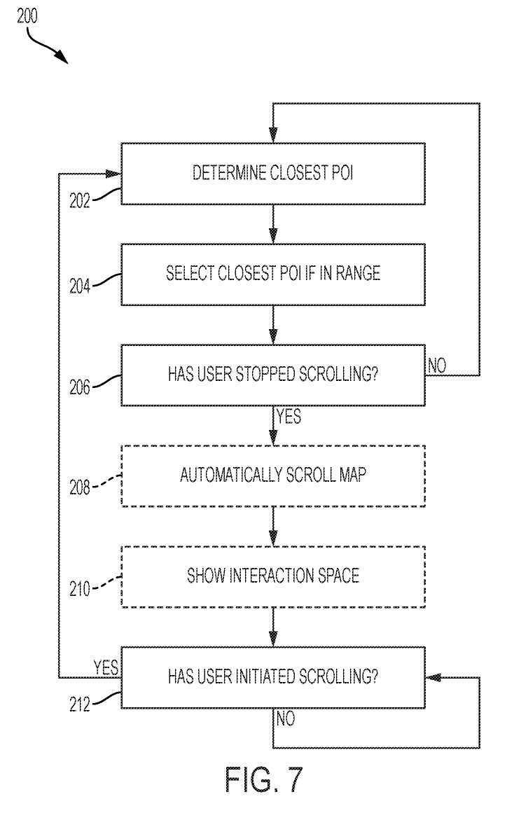

This section describes steps of an illustrative method 200 for providing a user interface for a map application; see FIG. 7. Aspects of map UIs described above may be utilized in the method steps described below. Where appropriate, reference may be made to previously described components and systems that may be used in carrying out each step. These references are for illustration, and are not intended to limit the possible ways of carrying out any particular step of the method.

FIG. 7 is a flowchart illustrating steps performed in an illustrative method, and may not recite the complete process or all steps of the method. FIG. 7 depicts multiple steps of a method, generally indicated at 200, which may be performed in conjunction with a map UI and associated software application, according to aspects of the present disclosure. Although various steps of method 200 are described below and depicted in FIG. 7, the steps need not necessarily all be performed, and in some cases may be performed in a different order than the order shown.

At step 202, the application may determine the closest point of interest (POI) to a selected reference point, also referred to as an interaction location. Distance to the various POIs on the screen may be determined based on geographical distance (e.g., using GIS data), and/or based on screen units (e.g., measured as a fraction or percentage of the screen size).

At step 204, the application may compare the distance to the closest POI with a selected maximum threshold distance. For example, the threshold may be equivalent to ⅛ of the screen height. If the POI falls within this distance (e.g., is “in range”), then the POI will be automatically selected by the program. This selection may trigger other actions, such as display of relevant POI information or changing of the POI's icon appearance.

At step 206, the program may check on whether the user has stopped scrolling. If not, steps 202 and/or 204 may be repeated (i.e., looped) until scrolling stops.

If scrolling has stopped, step 208 may include causing the map to automatically scroll relative to the fixed interaction location. More specifically, the map may be scrolled automatically to place the closest POI at the interaction location, or at a selected location defined relative to that interaction location. If no POI has met the distance threshold criteria at the time the user stops scrolling, this step may be bypassed or modified.

Optionally, step 210 may include displaying a user interaction space (also referred to as an interactive space), which may include action buttons, menu items, etc., relating to the POI, as described above.

Step 212 includes the system checking on whether the user has initiated scrolling, in which case the program will again loop through steps of the process, beginning with a determination of the closest POI in step 102.

A specific embodiment of method 200 is outlined below, in pseudocode.

```
    variable: interactionLocation = ConvertScreenLocation(X) To latitude + longitude
    Array: PointsOfInterest = [POI_1, POI_2, POI_3, POI_4, POI_5]
    Run the calculation every 0.1 sec while the user moves the map ->
    variable: smallestDistanceBetweenPOIandInteractionLocation = high number
    Loop through POI (x) times while x = number of POIs {
          distanceBetweenPOIandInteractionLocation = [calculation to find distance
between POI(x) and interactionLocation]
          if (distanceBetweenPOIandInteractionLocation <
smallestDistanceBetweenPOIandInteractionLocation) {
                smallestDistanceBetweenPOIandInteractionLocation =
distanceBetweenPOIandInteractionLocation
                closest POI = POI(x)
          }
    }
    if (closest POI distanceToInteractionLocation < distance chosen by programmer I
used 1/8 screen size) {
          select POI
          if (user has paused interaction with map or after some delay) {
                scroll map to put POI at proximate distance to Interaction Location
                optionally {
                      show interactive space to user (buttons, more information
about POI etc.)
                }
          }
    }
```

Illustrative Dynamic Distance Indication System for Map Applications

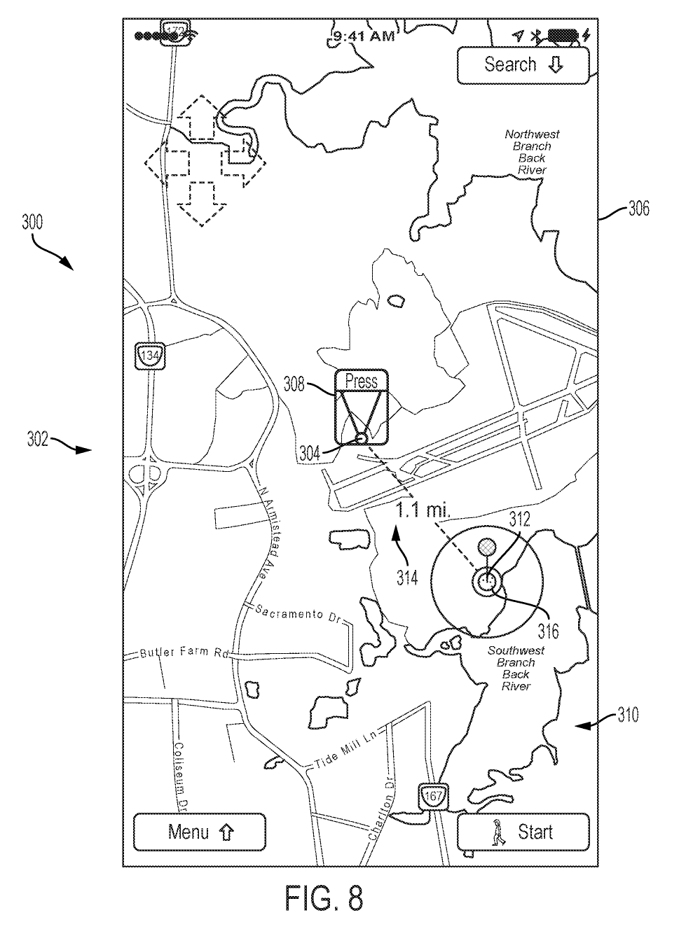

As shown in FIG. 8, this section describes a dynamic distance indication system 300 suitable for use in a map user interface (UI) system, either alone or in combination with aspects of systems 100 and/or 150, described above.

In general, and as partially shown in the example of FIG. 8, dynamic distance indication system 300 (also referred to as a dynamic distance indicator) according to the present teachings may include aspects of a map user interface (UI) 302 in which a static reference location 304 is defined on a user's screen 306. Static reference location 304 may be represented by a graphical element 308 such as an icon or pictogram. Static reference location 304 remains fixed, relative to screen 306, and may accordingly be referred to as a reference point or a screen static point. A map 310, which may include graphics, satellite imagery, etc., may be scrolled, panned, rotated, zoomed, or otherwise manipulated “under” reference point 304 and its associated graphical element 308. Screen static point 304 and/or graphical element 308 may be referred to as a cursor. The dynamic distance indication system further includes a map static point 312, which is a point on the map that remains geographically fixed. Map static point 312 may be established by user interaction with the system and/or by automatic definition by the program. POI 154 and POI 156, described above, are examples of map static points.

As shown in FIG. 8, system 300 dynamically displays indicia 314 regarding the distance between map static point 312 and the current map location corresponding to screen static point 304. Specifically, in this example, indicia 314 may include a line joining the two points (e.g., a dashed line) and a numerical distance indication (e.g., number of miles). Other indicia may be utilized, such as a bracket, a ruler, an arrow, and/or the like, or any combination of these. Distance may be determined mathematically by the program, using latitude and longitude of each point. In some examples, the distance includes a straight-line distance. In some examples, the distance includes a route distance, taking a selected course on the map.

Distance may be calculated and displayed dynamically on a substantially continual basis, until the user or the system causes a second map static point to be established (see examples below). After establishing the second map static point, the system may continue to display the dashed line and distance information, now relative to the second map static point rather than the first. In other words, the distance information may be continually displayed, relative to the latest map static point established, until the distance indication system is stopped. The system may be stopped or temporarily discontinued at the request of the user, based on an event, based on a cumulative distance, based on an elapsed timer, and/or the like.

Regarding map static point 312, an indicator or marker (e.g., a pushpin) may be “dropped” onto the map (e.g., by a user), to persistently mark the location of the map static point. As will be seen in this and other drawings, a present location 316 of the device may be indicated as a colored dot, surrounded by a white ring and semitransparent colored circle. In FIG. 8, present location 316 and the pushpin indicating point 312 happen to be coincidental. Tapping or pressing on the “Press” button of icon 308 may cause a recording of the map static point and the dropping of an indicator, e.g., a pushpin. Other suitable indicators and indicia may be utilized.

In some examples, a navigation route (e.g., turn-by-turn driving directions) may be displayed or otherwise presented (e.g., audibly) in response to the establishment of a second (or next) map static point. In some examples, a dynamically updated preview of the navigation route may be displayed as the user scrolls. For example, the route preview may be displayed when the user pauses for a selected amount of time. Additional details are described below.

### Illustrative Embodiment of a Dynamic Distance Indication System

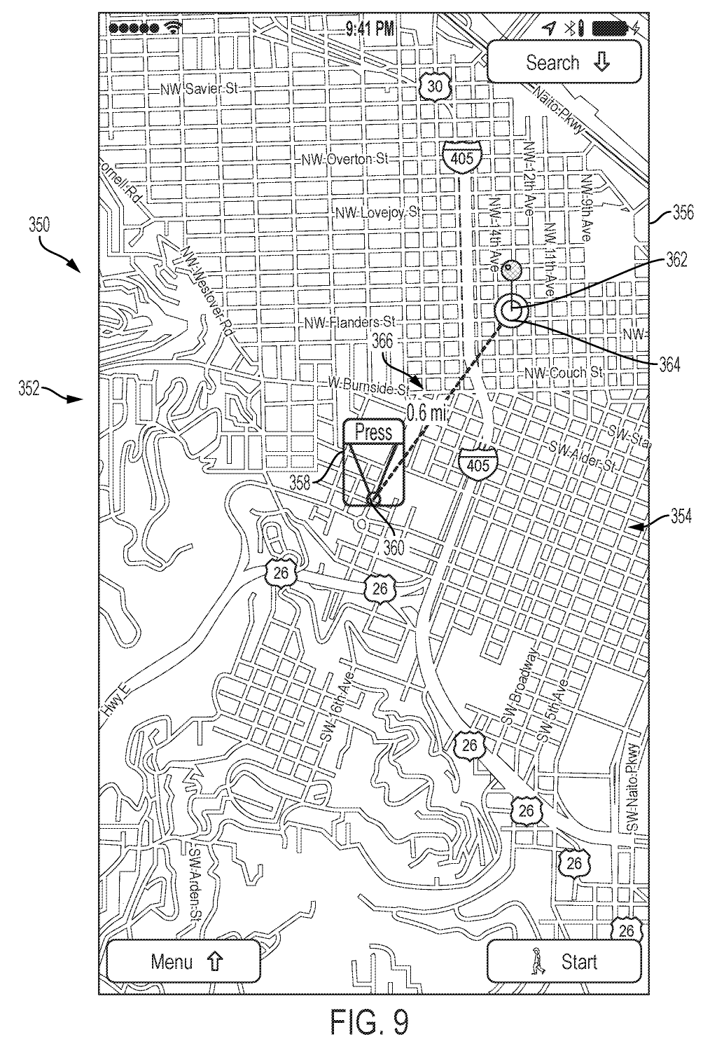

As shown in FIGS. 9-14, this section describes an illustrative dynamic distance indication system 350 for software map applications having map scrolling capabilities, including how the system may be used to gain information related to two selected points on a map, to automatically display a route preview, and to map a route between multiple map static points, among other features. This system is an example of system 300, described above. System 350 is also an example of systems 100 and 150. Accordingly, some or all of the features and components of those systems may be included, substantially as described above. The functionality described in this example may be present (on a permanent or selective basis) in any system described herein.

FIGS. 9-14 depict a user interface (UI) 352 for a map 354 displayed on a screen 356 of an electronic device running a geographical map application. An interaction icon 358, substantially similar to icon 160, indicates the location of a reference point 360, which is fixed at the geometrical center of the screen. In FIG. 9, a first map static point 362 has been established at a present location 364 of the device, e.g., by tapping or pressing icon 358. As discussed above, first map static point 362 could have been established at any suitable location. After establishing the first map static point, the user has scrolled map 354 (e.g., using a touch interface), such that first map static point 362 is a selected distance from reference point 360.

As discussed above with respect to system 300, system 350 automatically determines the geographical distance between the locations corresponding to first map static point 362 and reference point 360 (also referred to as a screen static point). Information regarding this distance is dynamically displayed and continually updated as the user scrolls map 354. As shown in the drawings, the information may be displayed as indicia 366 in the form of a line joining the two points (e.g., a dashed straight line) and a textual indication of the distance (e.g., “0.6 mi.”). The system will, dynamically, continuously, and in real time, display and update indicia 366. Zooming map 354 will cause the distance indication to change accordingly, depending on the current scale of map 354. Continuing to scroll map 354 may cause map static point 362 to go off-screen, i.e., beyond the edge of the displayed portion of the map. Nevertheless, the system may continue to display the line and distance, such that the line extends off-screen to where the map static point would be if displayed. Indicia 366 may have certain identifying characteristics, such as a color (e.g., red).

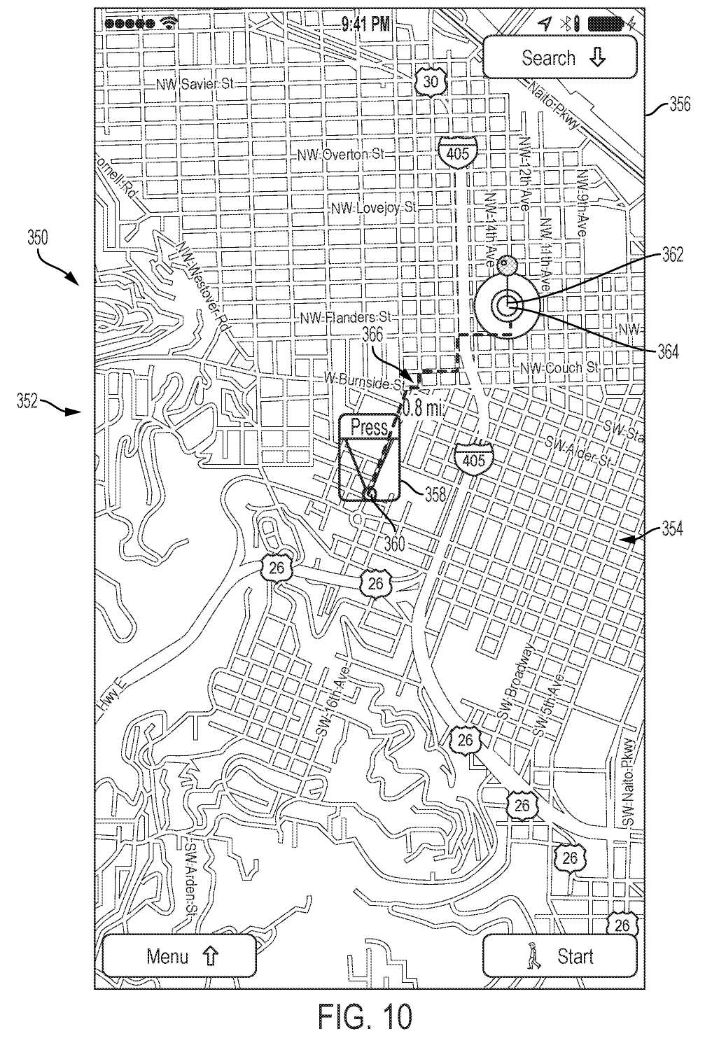

Turning to FIG. 10, a route preview function is shown. If the user pauses scrolling, the system may display a preview of the navigation route between the map static point and the screen static point. In some examples, the determination of whether a user has stopped or paused scrolling may include determining whether the user has removed a finger or other interaction device (e.g., a pen or stylus) from screen 356. In some examples, the determination of whether a user has stopped or paused scrolling may include waiting for a predetermined amount of time (e.g., 0.5 seconds). As shown in FIG. 10, the route preview causes the straight line of indicia 366 to transform into a street-following path, indicating the navigable route between map static point 362 and reference point 360. Resuming or continuing to scroll causes indicia 366 to again show the straight-line distance. Pausing again shows the route preview for the updated map location corresponding to the reference point.

With reference to FIG. 11, the user has determined that the present location at reference point 360 is to be the next point of interest. Accordingly, the user has tapped/pressed/clicked interaction icon 358 to place a second map static point 368. Doing so causes a display of a POI pop-up bubble 370 (similar to pop-up bubble 172) and a user menu and instruction space 372 (similar to interaction area 126 and space 176). In this example, pop-up bubble 370 displays an editable text label and the distance between the first two map static points, as well as the overall path distance. Also in this example, space 372 displays “move” and “delete” buttons, for interacting with map static point 368. Pressing the move button will remove map static point and permit a user to reestablish the map static point, retaining its position within the order of other map static points. Pressing the delete button will eliminate the map static point and directly join the immediately preceding and following map static points (if any).

Establishing second map static point 368 also causes the system to map the road-based route (e.g., turn-by-turn directions), and to display this portion of the overall path as a line 374 which may have different characteristics than the route preview line (e.g., may be a solid line as opposed to a dashed line). A straight-path line 376 is also displayed, e.g., in a different color, as an optional route that may be selected by the user instead of the road-based route. Route-portion-indicating lines 374 and 376 are persistent, absent user intervention.

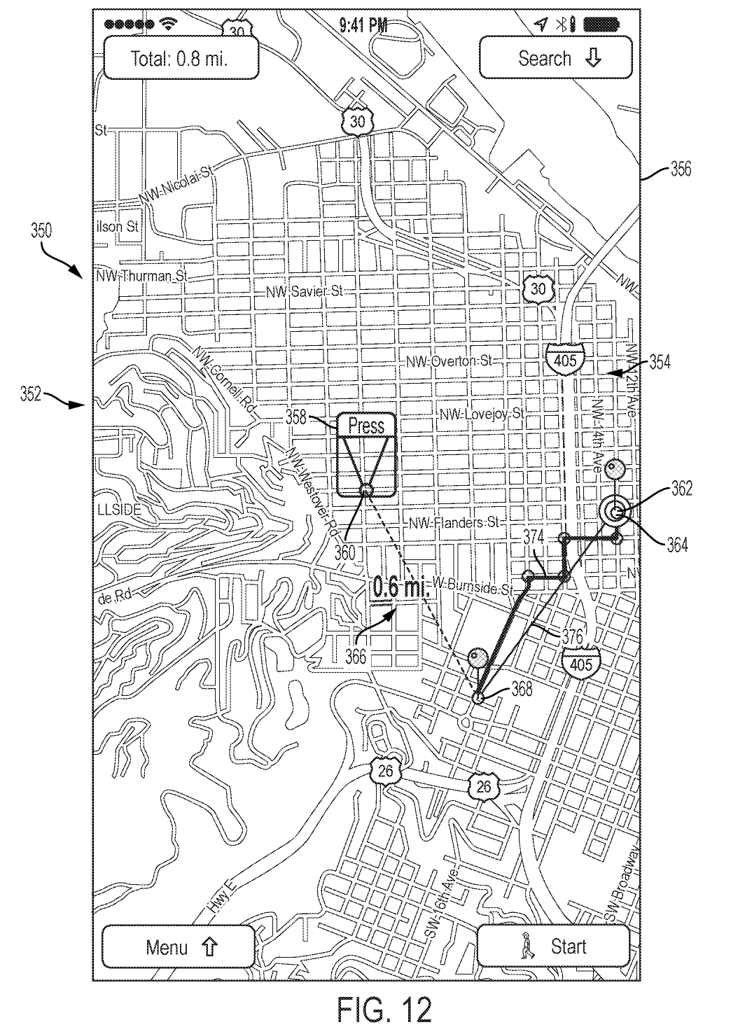

Turning to FIG. 12, the user has again scrolled interaction icon 358 away from second map static point 368 (actually scrolling the map while the icon remains stationary). In response, system 350 again presents indicia 366 to dynamically show the connection between the latest map static point and the present location corresponding to reference point 360.

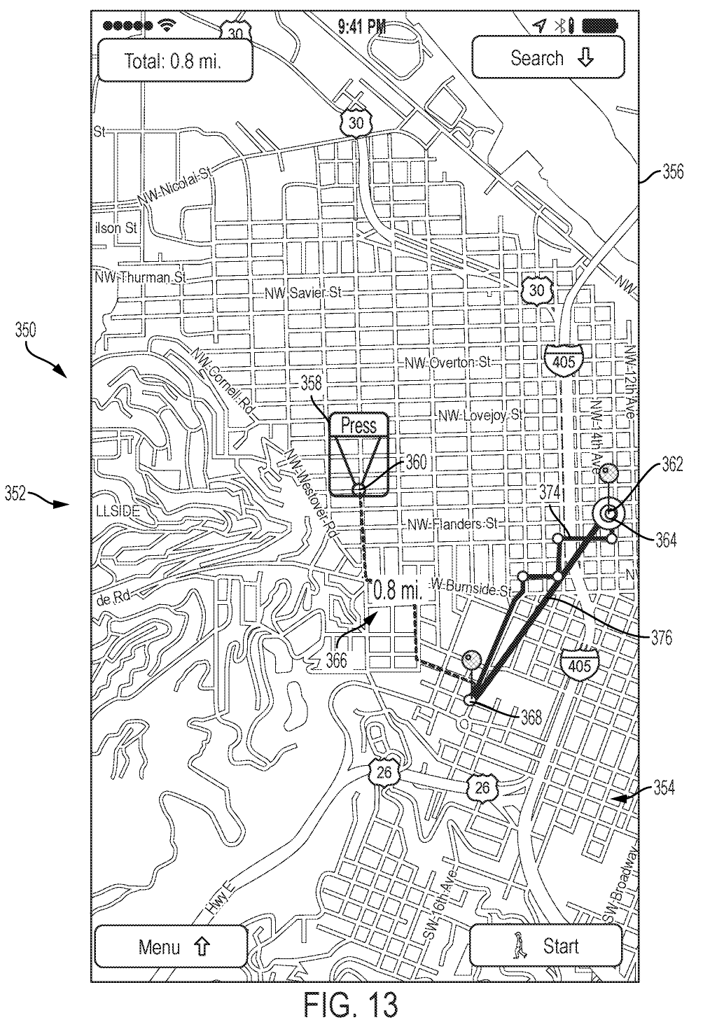

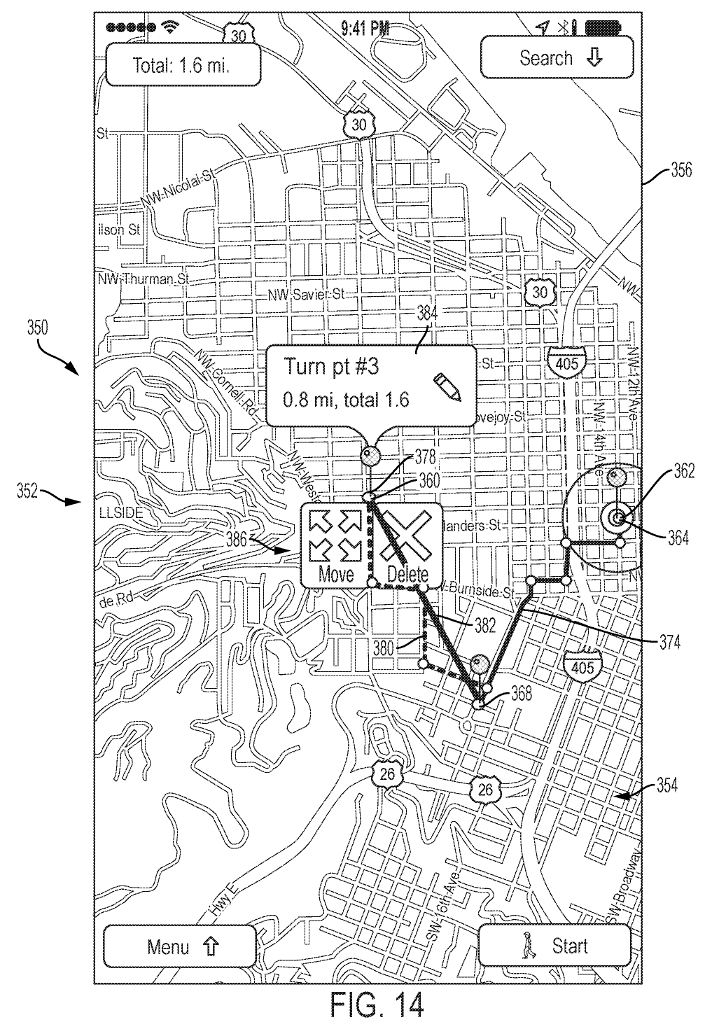

With reference to FIG. 13, the user again pauses scrolling, and the system updates indicia 366 to display a preview of the navigation route between the most recent map static point (i.e., point 368) and the screen static point (i.e., reference point 360). Continuing to scroll would cause the indicia to again show the straight-line distance. However, as shown in FIG. 14, the user instead clicked/pressed interaction icon 358 and established a third map static point 378. Similar to what happened with second map static point 368, this causes the system to display an actual navigation route 380 for the point 368 to point 378 segment of the path (e.g., in solid line), as well as the optional straight-line path segment 382, another pop-up bubble 384, and a menu and instruction space 386. In like manner, the user may continue to establish, delete, or reposition map static points to define an overall desired path. In some examples, the user may be presented with an option to link back to one of the previously established map static points (e.g., the first one), thereby forming a loop.

Illustrative Data Processing System

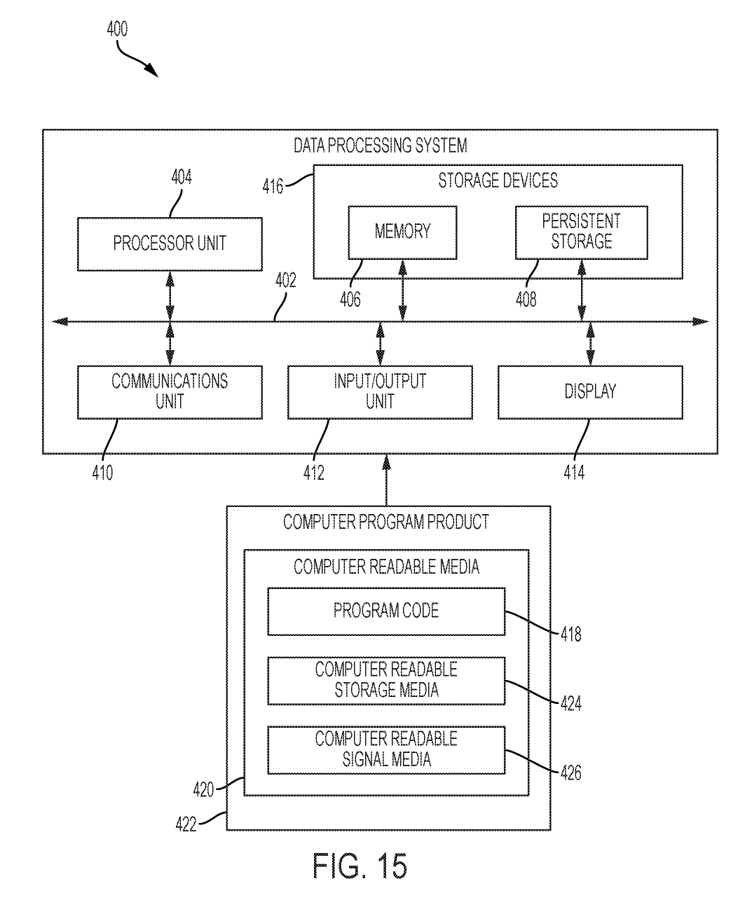

As shown in FIG. 15, this example describes an illustrative data processing system 400 (also referred to as a computer) in accordance with aspects of the present disclosure. In this example, data processing system 400 is an illustrative data processing system suitable for implementing aspects of the dynamic map UI systems described herein. More specifically, in some examples, devices that are embodiments of data processing systems (e.g., smartphones, tablets, personal computers) may be suitable for displaying a map UI having one or more features such as those described above, and/or for running described computer programs (i.e., map applications) and/or computer-implemented methods (e.g., method 200). In general, such devices may be used to display and/or process the user interfaces, distance indication, route and path mapping, and other aspects of the present disclosure.

Data processing system 400 includes communications framework 402. Communications framework 402 provides communications between processor unit 404, memory 406, persistent storage 408, communications unit 410, input/output (I/O) unit 412, and display 414. Memory 406, persistent storage 408, communications unit 410, input/output (I/O) unit 412, and display 414 are examples of resources accessible by processor unit 404 via communications framework 402.

Processor unit 404 serves to run instructions that may be loaded into memory 406. Processor unit 404 may be a number of processors, a multi-processor core, or some other type of processor, depending on the particular implementation. Further, processor unit 404 may be implemented using a number of heterogeneous processor systems in which a main processor is present with secondary processors on a single chip. As another illustrative example, processor unit 404 may be a symmetric multi-processor system containing multiple processors of the same type.

Memory 406 and persistent storage 408 are examples of storage devices 416. A storage device is any piece of hardware that is capable of storing information, such as, for example, without limitation, data, program code in functional form, and other suitable information either on a temporary basis or a permanent basis.

Storage devices 416 also may be referred to as computer-readable storage devices in these examples. Memory 406, in these examples, may be, for example, a random access memory or any other suitable volatile or non-volatile storage device. Persistent storage 408 may take various forms, depending on the particular implementation.

For example, persistent storage 408 may contain one or more components or devices. For example, persistent storage 408 may be a hard drive, a flash memory, a rewritable optical disk, a rewritable magnetic tape, or some combination of the above. The media used by persistent storage 408 also may be removable. For example, a removable hard drive may be used for persistent storage 408.

Communications unit 410, in these examples, provides for communications with other data processing systems or devices. In these examples, communications unit 410 is a network interface card. Communications unit 410 may provide communications through the use of either or both physical and wireless communications links.

Input/output (I/O) unit 412 allows for input and output of data with other devices that may be connected to data processing system 400. For example, input/output (I/O) unit 412 may provide a connection for user input through a keyboard, a mouse, and/or some other suitable input device. Further, input/output (I/O) unit 412 may send output to a printer. Display 414 provides a mechanism to display information to a user.

Instructions for the operating system, applications, and/or programs may be located in storage devices 416, which are in communication with processor unit 404 through communications framework 402. In these illustrative examples, the instructions are in a functional form on persistent storage 408. These instructions may be loaded into memory 406 for execution by processor unit 404. The processes of the different embodiments may be performed by processor unit 404 using computer-implemented instructions, which may be located in a memory, such as memory 406.

These instructions are referred to as program instructions, program code, computer usable program code, or computer-readable program code that may be read and executed by a processor in processor unit 404. The program code in the different embodiments may be embodied on different physical or computer-readable storage media, such as memory 406 or persistent storage 408.

Program code 418 is located in a functional form on computer-readable media 420 that is selectively removable and may be loaded onto or transferred to data processing system 400 for execution by processor unit 404. Program code 418 and computer-readable media 420 form computer program product 422 in these examples. In one example, computer-readable media 420 may be computer-readable storage media 424 or computer-readable signal media 426.

Computer-readable storage media 424 may include, for example, an optical or magnetic disk that is inserted or placed into a drive or other device that is part of persistent storage 408 for transfer onto a storage device, such as a hard drive, that is part of persistent storage 408. Computer-readable storage media 424 also may take the form of a persistent storage, such as a hard drive, a thumb drive, or a flash memory, that is connected to data processing system 400. In some instances, computer-readable storage media 424 may not be removable from data processing system 400.

In these examples, computer-readable storage media 424 is a physical or tangible storage device used to store program code 418 rather than a medium that propagates or transmits program code 418. Computer-readable storage media 424 is also referred to as a computer-readable tangible storage device or a computer-readable physical storage device. In other words, computer-readable storage media 424 is a media that can be touched by a person.

Alternatively, program code 418 may be transferred to data processing system 400 using computer-readable signal media 426. Computer-readable signal media 426 may be, for example, a propagated data signal containing program code 418. For example, computer-readable signal media 426 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 418 may be downloaded over a network to persistent storage 408 from another device or data processing system through computer-readable signal media 426 for use within data processing system 400. For instance, program code stored in a computer-readable storage medium in a server data processing system may be downloaded over a network from the server to data processing system 400. The data processing system providing program code 418 may be a server computer, a client computer, or some other device capable of storing and transmitting program code 418.

The different components illustrated for data processing system 400 are not meant to provide architectural limitations to the manner in which different embodiments may be implemented. The different illustrative embodiments may be implemented in a data processing system including components in addition to and/or in place of those illustrated for data processing system 400. Other components shown in FIG. 15 can be varied from the illustrative examples shown. The different embodiments may be implemented using any hardware device or system capable of running program code. As one example, data processing system 400 may include organic components integrated with inorganic components and/or may be comprised entirely of organic components excluding a human being. For example, a storage device may be comprised of an organic semiconductor.

In another illustrative example, processor unit 404 may take the form of a hardware unit that has circuits that are manufactured or configured for a particular use. This type of hardware may perform operations without needing program code to be loaded into a memory from a storage device to be configured to perform the operations.

For example, when processor unit 404 takes the form of a hardware unit, processor unit 404 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a field programmable logic array, a field programmable gate array, and other suitable hardware devices. With this type of implementation, program code 418 may be omitted, because the processes for the different embodiments are implemented in a hardware unit.

In still another illustrative example, processor unit 404 may be implemented using a combination of processors found in computers and hardware units. Processor unit 404 may have a number of hardware units and a number of processors that are configured to run program code 418. With this depicted example, some of the processes may be implemented in the number of hardware units, while other processes may be implemented in the number of processors.

In another example, a bus system may be used to implement communications framework 402 and may be comprised of one or more buses, such as a system bus or an input/output bus. Of course, the bus system may be implemented using any suitable type of architecture that provides for a transfer of data between different components or devices attached to the bus system.

Additionally, communications unit 410 may include a number of devices that transmit data, receive data, or both transmit and receive data. Communications unit 410 may be, for example, a modem or a network adapter, two network adapters, or some combination thereof. Further, a memory may be, for example, memory 406, or a cache, such as that found in an interface and memory controller hub that may be present in communications framework 402.

Any flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

Illustrative Distributed Data Processing System

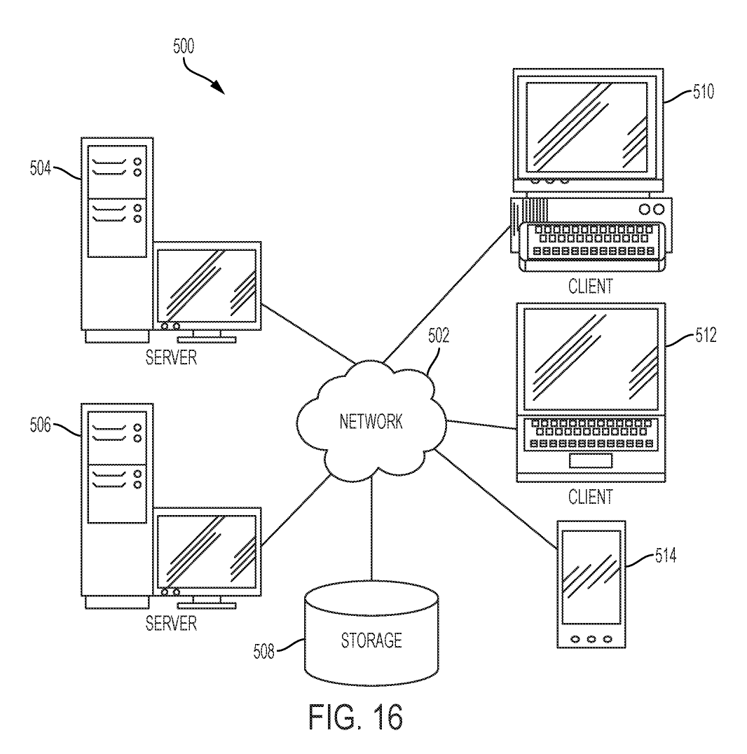

As shown in FIG. 16, this example describes an illustrative general network data processing system 500, interchangeably termed a network, a computer network, a network system, a distributed data processing system, or a distributed network, aspects of which may be included in one or more illustrative embodiments of the dynamic map UI systems described herein. For example, a mobile device may be connected to servers or other devices which may provide data to the mobile device for use in a map application. The map application itself, or portions thereof, may be executed on or over the network. For example, some UI features may be controlled and executed locally on the device, while other aspects, such as GIS data retrieval and/or user location information may be executed and/or communicated over one or more network(s). It should be appreciated that FIG. 16 is provided as an illustration of one implementation and is not intended to imply any limitation with regard to environments in which different embodiments may be implemented. Many modifications to the depicted environment may be made.

Network data processing system 500 is a network of computers, each of which is an example of data processing system 400, and other components. Network data processing system 500 may include network 502, which is a medium configured to provide communications links between various devices and computers connected together within network data processing system 500. Network 502 may include connections such as wired or wireless communication links, fiber optic cables, and/or any other suitable medium for transmitting and/or communicating data between network devices, or any combination thereof.

In the depicted example, a first network device 504 and a second network device 506 connect to network 502, as does an electronic storage device 508. Network devices 504 and 506 are each examples of data processing system 400, described above. In the depicted example, devices 504 and 506 are shown as server computers. However, network devices may include, without limitation, one or more personal computers, mobile computing devices such as personal digital assistants (PDAs), tablets, and smart phones, handheld gaming devices, wearable devices, tablet computers, routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices, such as a client computer 510, a client laptop or tablet 512, and/or a client smart device 514, may connect to network 502. Each of these devices is an example of data processing system 400, described above regarding FIG. 15. Client electronic devices 510, 512, and 514 may include, for example, one or more personal computers, network computers, and/or mobile computing devices such as personal digital assistants (PDAs), smart phones, handheld gaming devices, wearable devices, and/or tablet computers, and the like. In the depicted example, server 504 provides information, such as boot files, operating system images, and applications to one or more of client electronic devices 510, 512, and 514. Client electronic devices 510, 512, and 514 may be referred to as “clients” with respect to a server such as server computer 504. Network data processing system 500 may include more or fewer servers and clients or no servers or clients, as well as other devices not shown.

Client smart device 514 may include any suitable portable electronic device capable of wireless communications and execution of software, such as a smartphone or a tablet. Generally speaking, the term “smartphone” may describe any suitable portable electronic device having more advanced computing ability and network connectivity than a typical mobile phone. In addition to making phone calls (e.g., over a cellular network), smartphones may be capable of sending and receiving emails, texts, and multimedia messages, accessing the Internet, and/or functioning as a web browser. smart devices (e.g., smartphones) may also include features of other known electronic devices, such as a media player, personal digital assistant, digital camera, video camera, and/or global positioning system. smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and other devices to form a mobile network where information can be exchanged.

Program code located in system 500 may be stored in or on a computer recordable storage medium, such as persistent storage 408 described above, and may be downloaded to a data processing system or other device for use. For example, program code may be stored on a computer recordable storage medium on server computer 504 and downloaded for use to client 510 over network 502 for use on client 510.

Network data processing system 500 may be implemented as one or more of a number of different types of networks. For example, system 500 may include an intranet, a local area network (LAN), a wide area network (WAN), or a personal area network (PAN). In some examples, network data processing system 500 includes the Internet, with network 502 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 500 may be referred to as a “cloud.” In those examples, each server 504 may be referred to as a cloud computing node, and client electronic devices may be referred to as cloud consumers, or the like. FIG. 16 is intended as an example, and not as an architectural limitation for any illustrative embodiments.

### Additional Examples and Illustrative Combinations

This section describes additional aspects and features of dynamic user interfaces for software map applications having map scrolling capabilities, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A method, implemented in a data processing system, the method comprising:

displaying, on a screen of an electronic device, a scrollable map, one or more map static points on the map, and an interaction icon, wherein the interaction icon indicates an interaction location that is fixed relative to the screen;

determining, on a substantially continual basis as the map is scrolled relative to the interaction location, a first distance between the interaction location and a first map static point of the one or more map static points;

comparing the first distance to a selected threshold distance; and

in response to the first distance being less than the threshold distance, automatically displaying, on the screen, information relating to the first map static point.

A1. The method of A0, further comprising:

in response to a transition from scrolling of the map to a static display of the map, automatically scrolling the map on the screen to place the first map static point in a selected relationship with the interaction location.

A2. The method of any of paragraphs A1, A3, or A4, wherein automatically scrolling the map includes scrolling the map such that the first map static point registers with the fixed interaction location.

A3. The method of any of paragraphs A1 through A2 or A4, wherein the map is automatically scrolled only if the first distance is less than the threshold distance.

A4. The method of any of paragraphs A1 through A3, wherein the map is automatically scrolled only if the first map static point is closer to the fixed interaction location than any other map static point of the one or more map static points.

A5. The method of any of paragraphs A0 through A4, wherein the fixed interaction location is disposed at the geometric center of the screen.

A6. The method of any of paragraphs A0 through A5, wherein the first distance is determined as a fraction of a size of the screen.

A7. The method of any of paragraphs A0 through A6, further including establishing a new map static point at the present location corresponding to the interaction location, in response to activation of the interaction icon.

A8. The method of any of paragraphs A0 through A7, wherein the one or more map static points include one or more points of interest (POI).

A9. The method of any of paragraphs A0 through A8, further comprising:

automatically, as the map is scrolled relative to the interaction location, displaying indicia on the screen relating to a continually-updated distance between the interaction location and the first map static point.

B0. A computer-implemented digital map application comprising:

a digital map application configured to display, on a screen of an electronic device, a scrollable map, one or more map static points on the map, and an interaction icon, wherein the interaction icon corresponds to an interaction location that is fixed relative to the overall display; and

a user interface of the map application configured to automatically display indicia relating to a continually-updated distance between the interaction location and a selected one of the one or more map static points, as the map is scrolled relative to the interaction location.

B1. The application of B0, wherein the indicia include a line segment joining the interaction location and the selected map static point.

B2. The application of any of paragraphs B0 through B1, wherein the indicia include a numerical indication of linear distance.

B3. The application of any of paragraphs B0 through B2, wherein the user interface is further configured to provide a preview of a navigation route in response to a stoppage of scrolling for a selected duration.

B4. The application of any of paragraphs B0 through B3, wherein the selected map static point is the most recently established map static point.

B5. The application of any of paragraphs B0 through B4, wherein the user interface is further configured, in response to a stoppage of scrolling, to automatically scroll the map to register the selected map static point and the interaction location if the selected map static point is closer than a threshold distance from the interaction location.

C0. A computer program product for interacting with a scrollable digital map, the computer program product comprising

a non-transitory computer-readable storage medium having computer-readable program code embodied therewith, the computer readable program code configured to cause a data processing system to provide a graphical user interface, the computer readable program code comprising:

at least one instruction to display, on a screen of an electronic device, a scrollable map, one or more map static points on the map, and an interaction icon, wherein the interaction icon indicates an interaction location that is fixed relative to the screen;

at least one instruction to determine, on a substantially continual basis as the map is scrolled relative to the interaction location, a first distance between the interaction location and a first map static point of the one or more map static points;

at least one instruction to compare the first distance to a selected threshold distance; and

at least one instruction to, in response to the first distance being less than the threshold distance, automatically display, on the screen, information relating to the first map static point.

C1. The computer program product of C0, further comprising:

at least one instruction to, in response to a transition from scrolling of the map to a static display of the map, automatically scroll the map on the screen to place the first map static point in a selected relationship with the interaction location.

C2. The computer program product of any of paragraphs C1, C3, or C4, wherein automatically scrolling the map includes scrolling the map such that the first map static point registers with the fixed interaction location.

C3. The computer program product of any of paragraphs C1 through C2 or C4, wherein the map is automatically scrolled only if the first distance is less than the threshold distance.

C4. The computer program product of any of paragraphs C1 through C3, wherein the map is automatically scrolled only if the first map static point is closer to the fixed interaction location than any other map static point of the one or more map static points.

C5. The computer program product of any of paragraphs C0 through C4, wherein the fixed interaction location is disposed at the geometric center of the screen.

C6. The computer program product of any of paragraphs C0 through C5, wherein the first distance is determined as a fraction of a size of the screen.

C7. The computer program product of any of paragraphs C0 through C6, further comprising:

at least one instruction to establish a new map static point at the present location corresponding to the interaction location, in response to activation of the interaction icon.

C8. The computer program product of any of paragraphs C0 through C7, wherein the one or more map static points include one or more points of interest (POI).

C9. The computer program product of any of paragraphs C0 through C8, further comprising:

at least one instruction to, as the map is scrolled relative to the interaction location, automatically display indicia on the screen relating to a continually-updated distance between the interaction location and the first map static point.

D0. A data processing system for interacting with a digital map, the system comprising:

a processor;

a memory; and

a digital map program including a plurality of instructions stored in the memory and executable by the processor to:

carry out method steps as described in any of the paragraphs of A0 through C9, above.

### Advantages, Features, Benefits

The different embodiments and examples of the map UI described herein provide several advantages over known solutions regarding user interaction with software-based maps. For example, current solutions to interacting with POI on computerized maps involve touching them with a finger, stylus, or mouse pointer. This requires precise touch interactions made difficult through environmental or physical limitations. As an example: it is difficult touch a map with enough precision to select a point while in a passenger car on a bumpy road. Illustrative embodiments and examples described herein allow scrolling of the map to move a POI close enough to a reference screen location, which requires less precision by the user and makes for an easier interaction.

Additionally, and among other benefits, illustrative embodiments and examples described herein allow simplification of how a user interacts with a POI once it is selected. Current solutions allow users to select a POI at any screen location, creating technical and usability challenges. A major problem occurs when a POI is selected at a margin of the screen. In this instance, displaying information about (or buttons related to) the POI is a usability and technical problem. It is difficult to determine where on the screen to show an interactive space (buttons, detailed information), because an interactive space requires a significant portion of the screen. Accordingly, determining where to place it creates challenges. Current methods use two ways to work around these problems. The first is collocating the interactive space with a user selected POI, and covering arbitrary screen space somewhere near the POI. This cannot deliver a consistent positioning of the interaction space relative to the POI. For example, a POI on the left side of screen requires interactive space to its right, while a POI on the right side requires interactive space on its left. The second solution is to add interactive space in a consistent position on the screen regardless of a POI's screen location. This method means the user interactive space cannot be collocated with the POI. This also requires moving the POI once it is selected, or possibly covering the POI with the interactive space. Illustrative embodiments and examples described herein get around the consistency problem by requiring the selected POI to be positioned consistently on the screen, allowing for a consistently positioned, collocated user interactive space.

Additionally, and among other benefits, illustrative embodiments and examples described herein allow the system to maintain visibility of the POI at all times. Known solutions require the user to temporarily block the view of the desired POI with the selection apparatus (e.g., finger or stylus).

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A method, implemented in a data processing system, the method comprising:
displaying, on a screen of an electronic device, a scrollable map, one or more map static points on the map, and an interaction icon, wherein the interaction icon indicates an interaction location that is fixed relative to the screen;
determining, on a substantially continual basis as the map is scrolled relative to the interaction location, a first distance between the interaction location and a first map static point of the one or more map static points;
comparing the first distance to a selected threshold distance; and
automatically displaying on the screen, in response to the first distance being less than the threshold distance, information relating to the first map static point.

2. The method of claim 1, further comprising:
in response to a transition from scrolling of the map to a static display of the map, automatically scrolling the map on the screen to place the first map static point in a selected relationship with the interaction location.

3. The method of claim 2, wherein automatically scrolling the map includes scrolling the map such that the first map static point registers with the fixed interaction location.

4. The method of claim 2, wherein the map is automatically scrolled only if the first distance is less than the threshold distance.

5. The method of claim 2, wherein the map is automatically scrolled only if the first map static point is closer to the fixed interaction location than any other map static point of the one or more map static points.

6. The method of claim 1, wherein the first distance is determined as a fraction of a size of the screen.

7. The method of claim 1, further including establishing a new map static point at the present location corresponding to the interaction location, in response to activation of the interaction icon.

8. The method of claim 1, further comprising:
automatically, as the map is scrolled relative to the interaction location, displaying indicia on the screen relating to a continually-updated distance between the interaction location and the first map static point.

9. A computer-implemented digital map application comprising:
a digital map application configured to display, on a screen of an electronic device, a scrollable map, one or more map static points on the map, and an interaction icon, wherein the interaction icon corresponds to an interaction location that is fixed relative to the display; and
a user interface of the map application configured to automatically display indicia relating to a continually-updated distance between the interaction location and a selected one of the one or more map static points, as the map is scrolled relative to the interaction location.

10. The application of claim 9, wherein the indicia include a line segment joining the interaction location and the selected one of the one or more map static points.

11. The application of claim 9, wherein the indicia include a numerical indication of linear distance.

12. The application of claim 9, wherein the user interface is further configured to provide a preview of a navigation route in response to a stoppage of scrolling for a selected duration.

13. The application of claim 9, wherein the selected one of the one or more map static points is a most recently established map static point.

14. The application of claim 9, wherein the user interface is further configured, in response to a stoppage of scrolling, to automatically scroll the map to register the selected map static point and the interaction location if the selected map static point is closer than a threshold distance from the interaction location.

15. A computer program product for interacting with a scrollable digital map, the computer program product comprising
a non-transitory computer-readable storage medium having computer-readable program code embodied therewith, the computer-readable program code configured to cause a data processing system to provide a graphical user interface, the computer readable program code comprising:
at least one instruction to display, on a screen of an electronic device, a scrollable map, one or more map static points on the map, and an interaction icon, wherein the interaction icon indicates an interaction location that is fixed relative to the screen;
at least one instruction to determine, on a substantially continual basis as the map is scrolled relative to the interaction location, a first distance between the interaction location and a first map static point of the one or more map static points;
at least one instruction to compare the first distance to a selected threshold distance; and
at least one instruction to, in response to the first distance being less than the threshold distance, automatically display, on the screen, information relating to the first map static point.

16. The computer program product of claim 15, further comprising:
at least one instruction to, in response to a transition from scrolling of the map to a static display of the map, automatically scroll the map on the screen to place the first map static point in a selected relationship with the interaction location.

17. The computer program product of claim 16, wherein the map is automatically scrolled only if the first distance is less than the threshold distance.

18. The computer program product of claim 16, wherein the map is automatically scrolled only if the first map static point is closer to the fixed interaction location than any other map static point of the one or more map static points.

19. The computer program product of claim 15, further comprising:
at least one instruction to establish a new map static point at a map position corresponding to the interaction location, in response to activation of the interaction icon.

20. The computer program product of claim 15, further comprising:
at least one instruction to, as the map is scrolled relative to the interaction location, automatically display indicia on the screen relating to a continually-updated distance between the interaction location and the first map static point.
